(19) United States
(12) Patent Application Publication
(10) Pub. No.: US 2012/0164877 A1
(43) Pub. Date: Jun. 28, 2012

(54) METHOD AND APPARATUS FOR INSTALLING AN ACCESS POINT OVER AN ELECTRONIC WALL BOX

(75) Inventors: Patrick J. Wallace, San Jose, CA (US); Daran G. Hermans, San Jose, CA (US); John R. Marum, Oakland, CA (US); Harold H. Webber, Lafayette, CA (US)

(73) Assignee: SYMBOL TECHNOLOGIES, INC., Schaumburg, IL (US)

(21) Appl. No.: 12/980,299

(22) Filed: Dec. 28, 2010

(51) Int. Cl. H01R 13/60; H01R 43/00

(52) U.S. Cl. 439/535; 29/825

(57) ABSTRACT

An access point which is installed over the standard electronic wall box and provides access to different types of existing cables in a standard electronic wall box is disclosed. The access point includes at least one pass-through slot which houses a pass-through port. The pass-through port supports different types of connectors for different types of cables installed in the standard electronic wall box. The pass-through slot is used to expose the different types of connectors on the access point. The access point also includes a connection port to connect the access point to a wall cable which is a network uplink cable for connecting the access point to a network. The access point further includes an expansion slot to connect an expansion module to the access point. When the access point is installed on the standard electronic wall box, the pass-through slot is used to expose a cable that is different from the wall cable.

### FIELD OF THE DISCLOSURE

The present disclosure relates generally to installing an access point over a standard electronic wall box and more particularly to providing access to different types of cables installed in the standard electronic wall box.

### BACKGROUND

A Wireless Local Area Network (WLAN) is a data communication system that uses electromagnetic waves to transmit and receive data over the air, thereby minimizing the need for wired connections. A wireless access point is a specially configured node on the WLAN that acts as a central transmitter and receiver of the WLAN radio signals. The access point connects wireless devices within the WLAN and also can serve as the point of interconnection between the WLAN and a fixed wire network. Access points are generally small, dedicated hardware devices featuring, among other components, a built-in network adapter, an antenna, and a radio transmitter/receiver. At a minimum, the access point receives, buffers, and transmits data between the WLAN and the wired network. Access points support IEEE 802-11a, 802.11b, 802.11g, 802.11n or other similar wireless communication standards. (For any (IEEE) standards recited herein, contact the IEEE at IEEE, 445 Hoes Lane, PO Box 1331, Piscataway, N.J. 08855-1331, USA or see: http://standards.ieee.org/getieee802/index.html)

In a typical WLAN configuration, the access point is connected to the wired network from a fixed location with standard Ethernet cable. The access point is typically installed in a building, for example, on a ceiling or on a wall. The access point may be mounted essentially anywhere that is practical as long as the desired radio coverage is obtained. Because the access point is a single purpose device intended only for WLAN use, the access point is typically installed in a location that is hidden from view, so as not to distract from the aesthetic or décor of a room.

Some existing access points are designed to be aesthetically pleasing and to be blend in with the décor of any room. These access points may be shaped, for example, like a light switch cover or a thermostat cover and they may be installed on a wall-plate mounting over a standard electronic wall box. These access points are designed to include a number of Ethernet ports, some of which are managed by an internal Ethernet switch in the access point and at least one of which is a pass-through Ethernet port that is not managed by the internal Ethernet switch. One of the Ethernet ports, managed by the internal Ethernet switch, may be a power over Ethernet (PoE) port for providing power to devices, such as Voice over Internet Protocol (VoIP) phones or similar devices that require power and an Ethernet connection.

Different types of cables for connections other than Ethernet connections may be installed in the standard electronic wall box. Examples of some cables that are likely to be installed in the standard electronic wall box include fiber optic cables, coaxial cables, triaxial cables, or Bayonet Neill-Concelman (BNC) cables used to provide audio, video, television, or telephone services. When the access point is installed over the standard electronic wall box, the access point is connected to the wired network with an Ethernet cable that is also installed in the standard electronic wall box. The access point is then configured to provide Ethernet access through one of the Ethernet ports provided by the access point. After installation, however, the access point covers other cables in the standard electronic wall box that are not used for Ethernet connection. There is no current means in the access point for exposing these other cables in the standard electronic wall box that are not used for Ethernet connection. As such, to provide access to these cables, which are not Ethernet cables, an additional opening in the wall or ceiling will have to be provided. In buildings, for example hotels and hospitals, with brick walls or other solid construction, providing additional opening(s) to expose different types of existing cabling in the standard electronic wall box increases the costs and time associated with installing the access point.

Accordingly, there is a need for a method and apparatus that provides access to different types of existing cables in the standard electronic wall box when the access point is installed over the standard electronic wall box.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a Wireless Local Area Network used in accordance with some embodiments.

FIG. 2 is a diagram of an access point used in accordance with some embodiments.

FIG. 3 is another diagram of the access point used in accordance with some embodiments.

FIG. 4 is a flowchart of a method for providing access to different types of existing cables in a standard electronic wall box when an access point is installed over the standard electronic wall box in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to apparatuses and methods for providing access to different types of existing cables in a standard electronic wall box when an access point is installed over the standard electronic wall box. The access point includes at least one pass-through slot configured to expose a plurality of types of connectors for connecting a plurality of types of cables installed in the standard electronic wall box. The access point also includes a connection port configured to connect the access point to a wall cable. The wall cable is a network uplink cable for connecting the access point to a network. When the access point is installed on the standard electronic wall box, the pass-through slot is used to expose a cable connected to one of the plurality of types of connectors, wherein the cable is different from the wall cable.

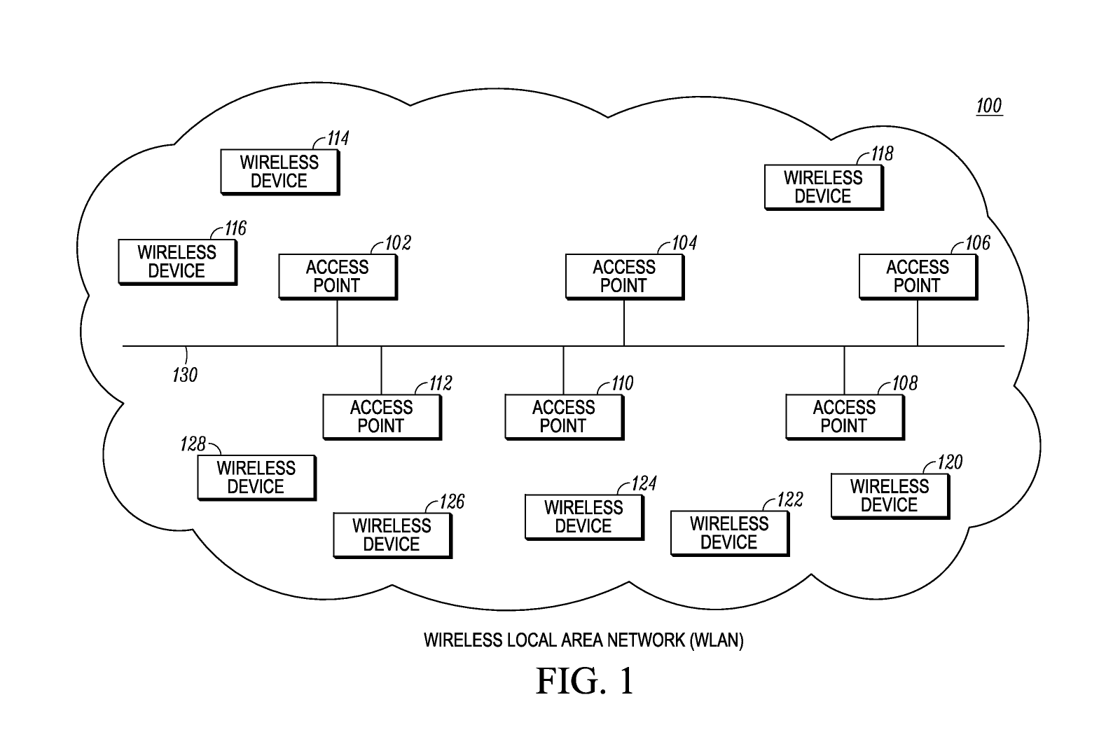

FIG. 1 is a block diagram of a Wireless Local Area Network used in accordance with some embodiments. Wireless Local Area Network (WLAN) 100 includes multiple access points 102-112 which link wired or wireless devices 114-128 on WLAN 100 to a wired network 130. Wireless devices 114-128 may be relatively stationary devices, such as desktop computers, televisions or similar devices with wired capabilities, or mobile devices such as laptops, smart phones, portable digital assistants, radios, or similar devices with wireless capabilities. In a typical WLAN configuration, each access point 102-112 is connected to wired network 130 from a fixed location with standard Ethernet cable and each access point 102-112 receives, buffers, and transmits data between WLAN 100 and wired network 130.

A single access point can support a small group of users and can typically function within a range of several hundred feet. Although the wireless coverage area for each access point is limited, access points 102-112 can be configured such that the coverage area of adjacent access points 102-112 overlap to provide a continuous wireless coverage area. The configurations and the number of access points 102-112 in WLAN 100 are used to determine the WLAN coverage area. WLAN 100 may be configured for a specific application and as such each access point 102-112 may be configured to provide wireless coverage for a specific purpose, for example, for a store, or for one or more rooms in a hospital, hotel, or dormitory. As noted previously, access points 102-112 support IEEE 802-11a, 802.11b, 802.11g, 802.11n or other similar wireless communication standards. (For any (IEEE) standards recited herein, contact the IEEE at IEEE, 445 Hoes Lane, PO Box 1331, Piscataway, N.J. 08855-1331, USA or see: http://standards.ieee.org/getieee802/index.html). It should be apparent to one skilled in the art that other components and configurations of WLAN 100 are not shown for the sake of simplicity.

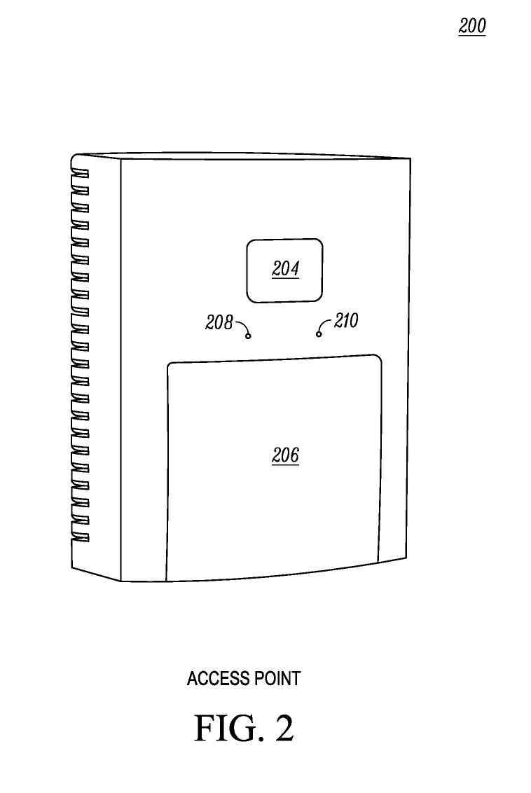

FIG. 2 is a diagram of an access point used in accordance with some embodiments. As is known to those skilled in the art, access point 200 can be built into different forms or shapes and may be, for example, access point 102-112 of FIG. 1. In some embodiments, access point 200 is configured in the shape of a standard telecommunication plate. In other embodiments, access point 200 may be shaped like a light switch cover or a thermostat cover. Access point 200 may be installed on a wall-plate mounting over a standard electronic wall box. The wall plate mounting may be placed over the standard electronic wall box and attached to the wall with, for example, a screw. In some embodiments, access point 200 is configured with hooks or other connection means for connecting the access point over to the wall plate mounting installed over the standard electronic wall box.

Access point 200 includes a pass-through slot 204 for housing a pass-through port. In FIG. 2, access point 200 is shown with a cover over pass-through slot 204. The pass-through port housed in pass-through slot 204 may be, for example, a Key Stone style port which supports a connector such as a registered jack (RJ) RJ-45 connector, RJ-11 connector, or F-connector. In some embodiments, access point 200 may include more than one pass-through slot. Pass-through slot 204 is configured to house different types of ports, each of which supports one or more connectors associated with existing cables in the standard electronic wall box. Therefore, pass-through slot 204 is used to expose existing cables in the standard wall plate on the face of access point 200. Access point 200 also includes a connection port (not shown) to connect access point 200 to an existing Ethernet cable, such as an RJ-45 cable. In some embodiments, the connection port is recessed in the rear of access point 200. When connected to access point 200, the existing Ethernet cable acts as a backhaul connection for access point 200 and acts as the network uplink for the WLAN connection.

Access point 200 further includes an expansion slot 206 for connecting a multi-port expansion module. Similar to port 204, in FIG. 2, access point 200 is shown with a cover over expansion slot 206. The multi-port expansion module includes a number of ports for connecting wired devices, such as televisions, telephones, or computers, to the network through access point 200. One or more of the ports on the multi-port expansion module may be a power over Ethernet (PoE) port. Access point 200 also includes internal Ethernet switch which uses the connection with the existing Ethernet cable to service both WLAN activity and to offer wired Ethernet connection(s) through the ports on the multi-port expansion module. For example, the internal Ethernet switch may be used to provide wireless services to wireless devices on the WLAN and/or and to offer wired Ethernet connection(s) to devices connected to access point 200 through the ports on the multi-port expansion module.

Access point 200 also includes an internal dual-band radio which supports radio bands, such as 802.11a/b/g/n radio bands, and internal firmware which enables access point 200 to boot up after it receives power or after it is reset. The firmware can be updated via, for example, an Ethernet interface. Access point 200 further includes light-emitting diode (LED) activity indicators 208 and 210 for providing a status display to indicate error conditions, transmissions, and network activities. In some embodiments, LED activity indicator 208 is used to provide a status display for a 2.4 gigahertz 802.11 b/g/n radio while LED activity indicator 210 is used to provide a status display of a 5 gigahertz 802.11 a/n radio.

In a typical room, for example a hotel room or a hospital room, a standard wall plate may be found near floor level (as an air conditioner outlet), near the middle of a wall (as a light switch cover, or a thermostat cover), or at spaces near the ceiling. An example of the standard wall plate may be a seventy by one hundred and twenty millimeter (70/120 mm) standard sized telecommunication plate with a RJ-45 Ethernet connector and a RJ-11 telephone connector. When the telecommunication plate is removed from the standard electronic wall box, access point 200 may be installed in its place and access point 200 is considered to be “hiding in plain sight”, as it does not detract from the décor of the room where it is installed. Installing access point 200 as the standard wall plate allows for better WLAN coverage in a multi-room building and allows for faster deployment over existing cables in the standard electronic wall box. In some embodiments, access point 200 is hooked on the wall plate mounting installed over the standard electronic wall box and access point 200 is configured to use the existing cables, used in other standard wall plates, in the standard electronic wall box. For example, access point 200 may be installed with an existing category five or higher cable, such as the RJ-45 cable, that is already installed in the standard electronic wall box.

At least one existing cable in the standard electronic wall box that is not used by access point 200 can be exposed through pass-through slot 204. Specifically, in some embodiments, a standard keystone style port or modular connector is installed in pass-through slot 204. Because audio, video, and data network cables typically use the keystone style connector, installing the standard keystone style port in pass-through slot 204 allows at least one existing cable in the standard electronic wall box to be mechanically exposed on the front face of access point 200, just as it would on any standard wall plate. As noted above, any style port that supports existing cables in the standard electronic wall box may be installed in pass-through slot 204. Access point 200 therefore functions as a wall plate which exposes existing cable connections and access point 200 also provides wired and/or wireless connections to devices in a predefined space. Access point 200 may also be installed on any flat surface, such as a desk or ceiling, such that it does not protrude into the flat surface. For example, access point 200 may also be installed on a wall so that it does not protrude into the wall, thereby allowing for efficient heat transfer in the wall.

Access point 200 may be configured to function as a central controller for a number of other access points. In particular, access point 200 may include a processor to provide central configuration and automatic radio frequency management functions for a predefined number of other access points in the wireless network. In some embodiments, any two access points can be designated as controller access points, one as the primary controller access point and one as a backup controller access point. This allows any network with up to a predefined number of access points to be managed without the expense of a radio frequency controller. It should be apparent to one skilled in the art that other configurations and components of access point 200 are not shown for the sake of simplicity.

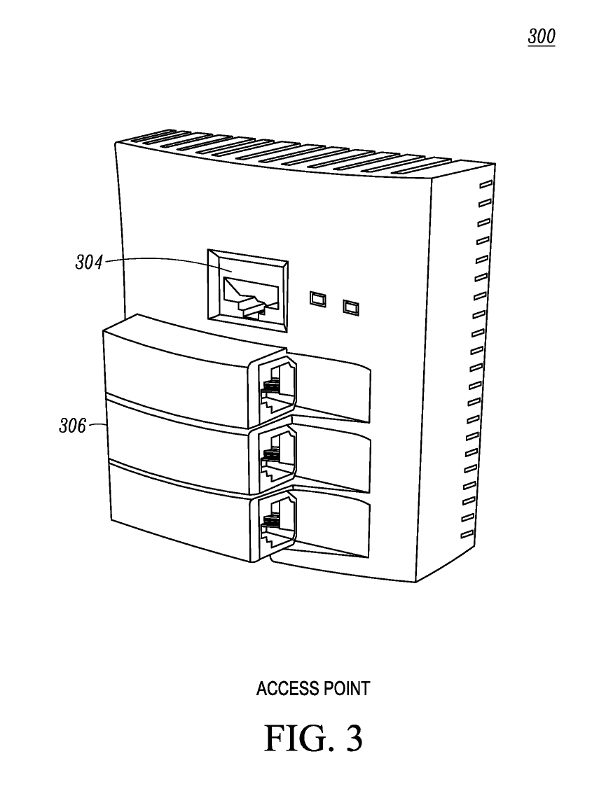

FIG. 3 is another diagram of the access point used in some embodiments. Access point 300 is the same as access point 200, except that access point 300 is shown with a pass-through port 304 and a multi-port expansion module 306. Pass-through port 304 is installed in the space shown in FIG. 2 as pass-through slot 204. Pass-through port 304 is a standard keystone style port and it is used to expose existing cable in the standard electronic wall box on the front face of access point 300. Multi-port expansion module 306 is installed in the space shown in FIG. 2 as expansion slot 206. Multi-port expansion module 306 includes a number of ports for connecting wired devices, such as televisions, telephones, or computers, to the network through access point 300. Although FIG. 3 shows multi-port expansion module 306 with three ports, it should be noted that multi-port expansion module 306 may be configured to include any number of ports. Multi-port expansion module 306 is therefore used to add switched Ethernet ports or other ports, for example for television or telephone, to access point 300. Access point 300 modular design and expansion capabilities allow switched Ethernet ports to be added to access point 300 as-needed. It should be apparent to one skilled in the art that other configurations and components of access point 300 are not shown for the sake of simplicity.

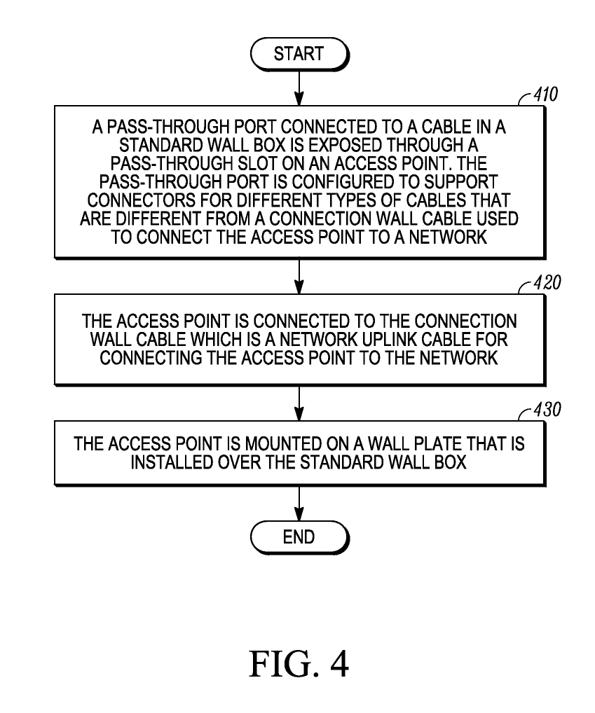

FIG. 4 is a flow diagram of a method for installing an access point over a standard electronic wall box. In 410, a pass-through port connected to a cable in a standard electronic wall box is exposed through a pass-through slot on an access point. The pass-through port is configured to support connectors for different types of cables that are different from a connection wall cable used to connect the access point to a network. In 420, the access point is connected to the connection wall cable which is a network uplink cable for connecting the access point to the network. In 430, the access point is mounted on a wall plate that is installed over the standard electronic wall box.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An access point, comprising:
at least one pass-through slot configured to expose a plurality of types of connectors for connecting a plurality of types of cables installed in a standard electronic wall box; and
a connection port configured to connect the access point to a wall cable, wherein the wall cable is a network uplink cable for connecting the access point to a network,
wherein when the access point is installed on the standard electronic wall box, the at least one pass-through slot is used to expose a cable connected to one of the plurality of types of connectors, wherein the cable is different from the wall cable.

2. The access point of claim 1, further comprising an expansion slot configured to house an expansion module connected to the access point, wherein the expansion module provides additional ports for connecting wired devices to the access point.

3. The access point of claim 2, further comprising an internal switch which is configured to provide network access to wired devices connected to the access point through the expansion module and to wireless devices connected to the access point.

4. The access point of claim 1, further comprising a dual-band radio for transmitting to and receiving wireless signals from wireless devices connected to the access point and firmware for powering up the access point.

5. The access point of claim 1, further comprising activity indicators for providing a status display to indicate error conditions, transmission, and network activities on the access point.

6. The access point of claim 2, wherein the expansion module includes multiple ports, wherein each port is used to connect a wired device to the network through the access point.

7. The access point of claim 1, wherein the connection port is located in a rear of the access point.

8. The access point of claim 1, wherein the at least one pass-through slot is located on a front face of the access point.

9. The access point of claim 1, further comprising hooking means for connecting the access point to a wall mounting plate installed over the standard electronic wall box.

10. The access point of claim 1, wherein the access point is configured to function as a central controller for a predefined number of other access points.

11. The access point of claim 1, wherein the access point is configured to function as at least one of a primary central controller or a backup central controller.

12. A method for installing an access point over a standard electronic wall box, comprising:
exposing a pass-through port connected to a cable in a standard electronic wall box through a pass-through slot on an access point, wherein the pass-through port exposes a plurality of types of connectors for connecting a plurality of types of cables installed in the standard electronic wall box;
connecting the access point to a connection wall cable, wherein the connection wall cable is a network uplink cable for connecting the access point to a network and the connection wall cable is different from the cable connected to the pass-through port; and
mounting the access point on a wall plate that is installed over the standard electronic wall box.

13. The method of claim 12, further comprising connecting an expansion module to the access point through an expansion slot on the access point.

14. The method of claim 13, providing network access to wired devices connected to the access point through the expansion module and to wireless devices connected to the access point.

15. The method of claim 13, wherein the expansion module includes multiple ports, wherein each port is used to connect a wired device to the network through the access point.
